(19) United States
(12) Patent Application Publication
(10) Pub. No.: US 2005/0266710 A1
(43) Pub. Date: Dec. 1, 2005

(54) Switching plug structure with resistor

(76) Inventor: Yau-Tzung Liu, Shu Lin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/855,516

(22) Filed: May 28, 2004

(51) Int. Cl. H01R 33/00

(52) U.S. Cl. 439/170

(57) ABSTRACT

A switching plug structure has a plug and having a switching connecter. Each of the plug and the switching connecter respectively has a plurality of first terminal ends and a plurality of second terminal ends respectively corresponding to the first terminal ends. A middle connecter interconnects the plug and the switching connecter. The middle connecter has a plurality of third terminal ends and fourth terminal ends therein. A resistor interconnects one of the plurality of third and one of fourth terminal ends. The middle connecter is detachably interconnecting the plug and the switching connecter, interconnecting the third terminal ends and the first terminal ends, and interconnecting the fourth terminal ends and the second terminal ends, so as to form a switching plug structure with the resistor

### BACKGROUND OF THE INVENTION

1. Field of the Invention

The present invention relates to a switching plug structure with resistor, and more especially to a switching plug structure for connecting one end of a power wire and providing different voltages by means of exchanging a middle connecter.

2. Description of the Related Art

Referring to FIG. 1, a conventional DC type power wire 70 connects with a switching plug 80, which includes a plug 81 connecting with one end of the power wire 70 and a detachable switching connecter 82. The plug 81 has three jacks 83, each of which has a first terminal end 84 electrically connecting with the power wire 70. Correspondingly, one end of the switching connecter 82 has three corresponding second terminal ends 85. The terminal ends 85 insert into the jacks 83, enabling the switching connecter 82 to plug detachably into the plug 81 and each of the second terminal ends 85 can respectively contact the corresponding first terminal end 84 to connect electrically with the two groups of terminal ends 84, 85. Thus, the switching connecter 82 can electrically connect with the plug 81 and the power wire 70 for transmitting electric power to the switching connecter 82 through the plug 81.

Since the switching connecter 82 detachably connects with the power wire 70, the power wire 70 can be applied to different sockets, having different specifications, of electrical equipment having different specifications, rather than replacing the power wire 70, thus cutting down the manufacturing costs and mitigating the user's burden.

However, the conventional power wire 70 can only adapt to a particular voltage of an exclusive specification, rather than adapt to all voltages in a range of 15 v, 16 v, 17 v, 19 v, 20 v or 22 v of common electric equipment, thus limiting the applicability of the power wire 70.

Referring to FIG. 2, another kind of switching plug is shown. The switching connecter 82 of the switching plug 80 further defines a first body 86 and a second body 87 interconnecting with each other by a wire 88. A resistor is arranged in a appropriate position in the switching connecter 82 (not shown), sharing part of voltage born by the power wire 70. This kind of switching plug can provide different voltages as required by electric equipment and extends the applicability of power wire 70, thus obviating the need to replace the power wire 70 for application to different electric equipment. However, the switching connecter 82 must still be replace as a whole to attain a different switching connecter 82 having different resistor values.

Therefore, the conventional switching plug structures mentioned above have drawbacks and inconveniences and should be improved.

### SUMMARY OF THE INVENTION

Accordingly, an object of the present invention is to provide a switching plug structure with resistor. By replacing a middle connecter with resistor, the switching plug structure can provide different voltages as needed by electric equipment need and extending the applicability of a power wire, rather than replacing the power wire for use with different electric equipment. Thus, the manufacturing costs can be cut down and the user's burden can be mitigated.

Accordingly, a switching plug structure having resistor in accordance with the present invention is provided. The switching plug structure comprises a plug including a switching connecter. Each of the plug and the switching connecter respectively has a plurality of first terminal ends and a plurality of second terminal ends respectively corresponding the first terminal ends. A middle connecter interconnects the plug and, the switching connecter. The middle connecter has a plurality of third terminal ends and fourth terminal ends therein. A resistor interconnects one of the pluralities of third and one of fourth terminal ends. The middle connecter detachably interconnects the plug and the switching connecter, interconnects the third terminal ends and the first terminal ends, and interconnects the fourth terminal ends and the second terminal ends.

To achieve the above objects, a switching plug structure with a detachable camera module is described, comprising a body and a built-in camera module detachably fixed on the body of the switching plug structure.

### BRIEF DESCRIPTION OF THE DRAWINGS

Other objects, advantages and novel features of the present invention will be apparent from the following detailed description of preferred embodiments thereof with reference to the attached drawings, in which:

FIG. 1 is a perspective, disassembled view of a conventional switching plug structure;

FIG. 2 is a perspective, disassembled view of another conventional switching plug structure;

FIG. 3 is a perspective, disassembled view of a switching plug structure of the present invention;

FIG. 4 is a perspective, assembled view of the switching plug structure of the present invention;

FIG. 5 is a top, explanatory view of the switching plug structure of the present invention; and

FIG. 6 is a perspective view of a middle connector of the switching plug structure of the present invention.

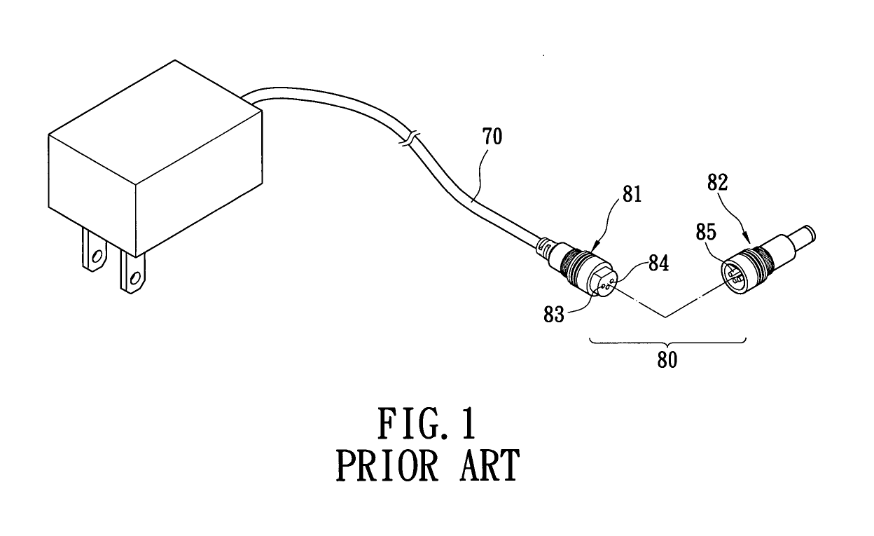

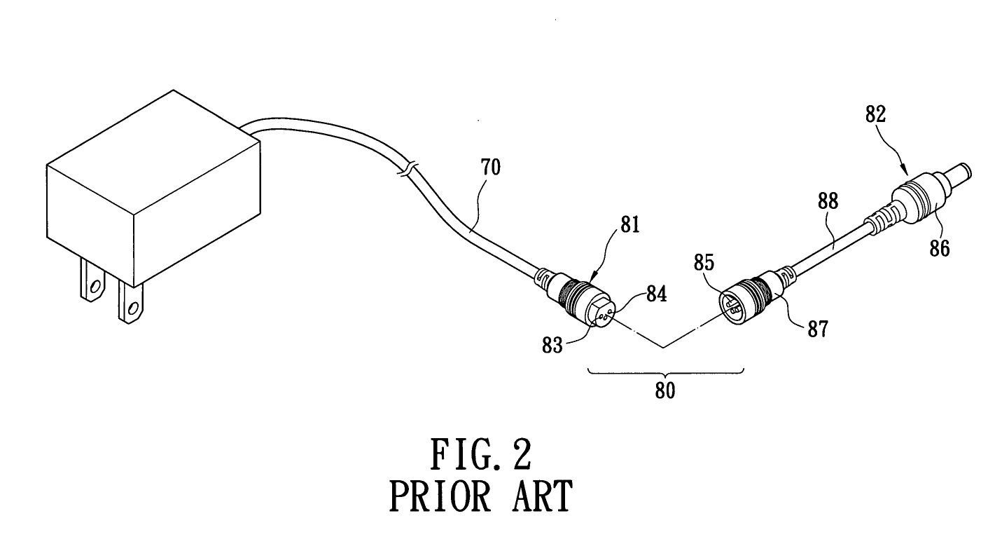

### DETAILED DESCRIPTION OF THE PREFERRED EMBODIMENTS

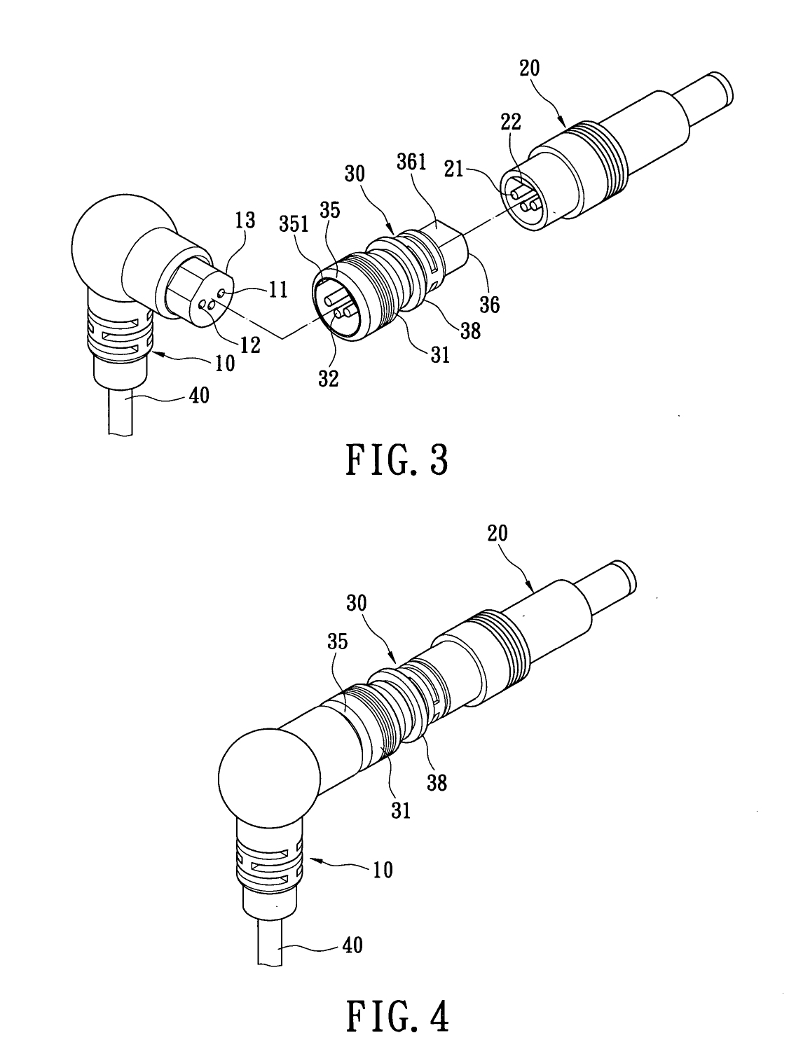

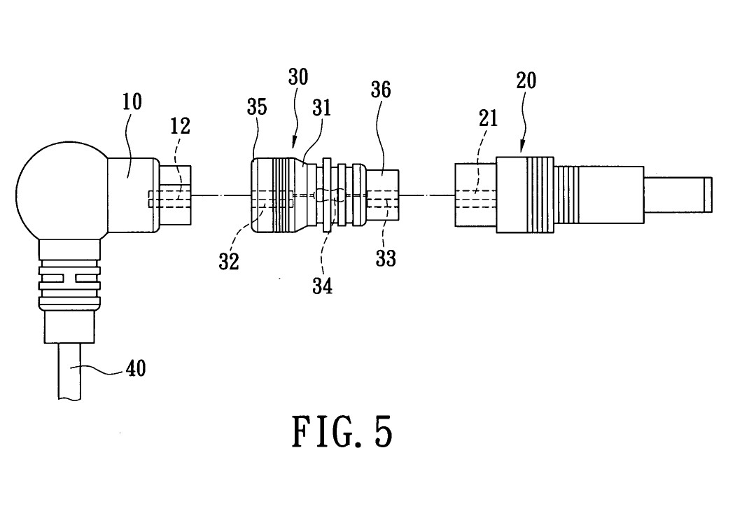

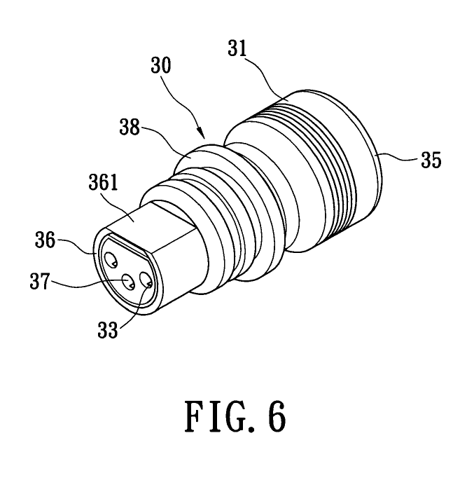

Referring to FIGS. 3 to 5, a switching plug structure with resistor is provided in accordance with the present invention. The switching plug structure connects with one end of a DC type power wire 40. The switching plug structure includes a plug 10 connecting with one end of the power wire 40, a detachable switching connecter 20 and a middle connecter 30 interconnecting the plug 10 and the switching connecter 20. The plug 10 has a plurality of, such as, for example, three, first jacks 11 extending inward a appropriate length. Each of the first jacks 11 forms a first terminal end made of metal material with good conductivity. Each of the first jacks 11 electrically connects with a corresponding lead (not shown) inside the power wires 40. One end of the switching connecter 20 has a plurality of second terminal ends 21 respectively corresponding to the first jacks 11 and the first terminal ends 12. The plurality of second terminal ends 21 is made of metal material with good conductivity.

An important aspect of the present invention is setting the middle connecter 30 between the plug 10 and the switching connecter 20. The middle connecter 30 includes an insulated body 31, a plurality of third terminal ends 32, a plurality of fourth terminal ends 33 and at least a resistor 34 (seen FIG. 6). The insulated body 31 is made of plastic, two opposing ends of which respectively form a first plug portion 35 and a second plug portion 36 respectively corresponding to one end of the plug 10 and one end of the switching connecter 20. The first and second plug portions 35, 36 interconnect with corresponding ends of the plug 10 and the switching connecter 20, i.e. the first plug portion 35 encloses the end of the plug 10, and the second plug portion 36 is inserted inside the end of the switching connecter 20, so the middle connecter 30 can detachably interconnect the plug 10 and the switching connecter 20.

In addition, each of the first, second plug portions 35, 36 respectively has a section 351, 361, and each of the plug 10, the switching connecter 20 has a corresponding section 13, 22 formed on a respective end, so as to form a dull-prevented structure. Thus, the middle connecter 30 is secured between the plug 10 and the switching connecter 20 in a given direction, only, so as to obtain a dull-prevented function.

The plurality of third and fourth terminal ends 32, 33 within the insulated body 31 are all made of metal material with good conductivity, located oppositely at two ends of inside of the insulated body. One end of each the plurality of the third terminal ends 32 is fixed in the first plug portion 35, so as to electrically interconnect the corresponding first terminal ends 12 of the plug 10 when the first plug portion 35 of the middle connecter 30 is plugged into one end of the plug 10. One end of each the plurality of the fourth terminal ends 33 is fixed in a plurality of corresponding jacks 37 of the second plug portion 36, so as to electrically interconnect the corresponding second terminal ends 21 of the switching connecter 20 embedded in the corresponding jacks 37 when the second plug portion 36 of the middle connecter 30 is plugged into one end of the switching connecter 20.

Each of the plurality of third terminal ends 32 and fourth terminal ends 33 have a terminal end 32, 33 grounded. The resistor 34 has two terminal ends respectively connected with the terminal ends 32, 33. The other third terminal ends 32 and fourth terminal ends 33 interconnect electrically and individually with each other. The value of the resistor 34 is not limited, and can be set at different values in accordance with practical circumstances. The exterior of the insulated body 31 of the middle connecter 30 forms a mark 38 for indicating the value of the resistor 34 utilizing a digit or color.

The present invention is mainly implemented by setting the middle connecter 30 between the plug 10 and the switching connecter 20; meanwhile, the resistor 34 is fixed in the middle connecter 30. Thus, the voltage born by the power wire 40 can be changed utilizing the resistor 34; i.e. the switching plug structure can provide different voltages needed by electric equipment need and the applicability of power wire 40 is extended, thus obviating the need to replace the power wire 40 for application with different electric equipment. In addition, the plug 10 and the switching connecter 20 need not be replaced as long the middle connecter 30 having the resistor 34 with different values is replaced. Thus, the manufacturing costs can be cut down and the user's burden can be mitigated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A switching plug structure comprising:
a plug connected to power wires on one end thereof and having a plurality of first terminal ends at an opposing end;
a switching connecter having one end with a plurality of second terminal ends respectively corresponding the first terminal ends; and
a middle connecter including (a) an insulated body having a cavity formed in one end thereof and a plurality of openings in an opposing end, A) a plurality of third terminal ends disposed within the cavity (c) a plurality of fourth terminal ends respectively disposed within the plurality of openings, and (d) a resistor disposed within the insulated body and electrically connected in series relationship between one of the third terminal ends and one of the fourth terminal ends, and other of the third terminal ends being respectively electrically interconnected with the other fourth terminal ends;
wherein the middle connecter detachably interconnects the plug and the switching connecter, interconnects the third terminal ends and the first terminal ends, and interconnects the fourth terminal ends and the second terminal ends.

2. The switching plug structure as described in claim 1, wherein the plug has a plurality of first jacks extending inward, the first terminal ends being received in the first jacks respectively, inside ends thereof connecting electrically with corresponding power wires.

3. The switching plug structure as described in claim 1, wherein two opposing ends of the middle connecter respectively form a first plug portion and a second plug portion, the first, second plug portions interconnecting with corresponding ends of the plug and the switching connecter.

4. The switching plug structure as described in claim 3, wherein the first plug portion is defined by the cavity of the middle connector to thereby envelope the end of the plug when connected thereto, and the second plug portion inserts inside the end of the switching connecter.

5-6. (canceled)
